(19) United States
(12) Patent Application Publication
(10) Pub. No.: US 2006/0185607 A1
(43) Pub. Date: Aug. 24, 2006

(54) Litter box safety guard

(76) Inventors: Katherine LeCavalier, Rutherfordton, NC (US); Robin LeCavalier, Rutherfordton, NC (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/327,186

(22) Filed: Jan. 7, 2006

Related U.S. Application Data
(60) Provisional application No. 60/642,258, filed on Jan. 8, 2005.

(51) Int. Cl. A01K 29/00

(52) U.S. Cl. 119/165

(57) ABSTRACT

A litter box safety guard. The guard is affixed to a top portion of a cat litter box cover for preventing other pets and children from entering the litter box cover or otherwise gaining access to the litter material within the cover. The guard comprises a upper member affixed to a top surface of the cover, a front member affixed to and extending downwardly from the top member, a floor member extending from the front member and a support member for resting on a bottom edge of the cover opening. The litter box safety guard thereby functions as a barrier to dogs and children attempting to enter the litter box cover, while permitting a cat to easily crawl through the safety guard to enter the litter box cover. The litter box safety guard does not interfere with separation of the top and bottom portions of the litter box cover to dean or replace the litter material.

### CROSS-REFERENCE TO RELATED APPLICATIONS

This patent application claims the benefit of the provisional patent application filed on Jan. 8, 2005 and assigned application Ser. No. 60/642,258.

### FIELD OF THE INVENTION

The present invention relates generally to animal (in particular cat) litter boxes, and specifically to an animal litter box cover having a restricted opening for limiting access by children and other pets to the litter box enclosed within the cover, while permitting cats to enter through the opening.

### BACKGROUND OF THE INVENTION

It is known that silica components of clay litter (e.g., cat litter) can cause serious illnesses if ingested or inhaled. Silica is considered toxic by the Environmental Protection Agency (EPA) and is listed as a carcinogen by the California EPA. Certain recent cat litter formulations (referred to as crystal cat litter) comprise silica as the primary component. In addition to the use of toxic silica, potentially dangerous chemicals may be added to the litter to retard dust and mask odors.

Silicosis (a condition resulting from the ingestion or inhalation of silica) symptoms can develop within weeks of silica exposure. In other cases the symptoms do not immediately present, but instead develop gradually over a period of several years of relatively consistent silica exposure.

Clumping day litter is especially convenient for the cat owner, as the clumped litter is easier to scoop than loose granular litter, simplifying the daily litter box cleaning task. But ingestion of sodium bentonite, a litter additive that solidifies liquid wastes, reportedly can cause serious or fatal health problems in dogs and humans. Ingested sodium bentonite absorbs liquids in the gut, solidifying digested food and blocking the digestive tract. Even if complete blockage does not occur, the sodium bentonite reduces the ability of the digestive tract to absorb minerals and nutrients from food. These impairments may lead to dehydration and compromise the immune system. Chronic ingestion of cat litter containing sodium bentonite also appears to be associated with hypokalemia, lethargy and muscle weakness, heart murmurs and macrocytic hypochromic anemia.

Additionally, bentonite ingestion can cause numerous food and skin allergies, coughing, vomiting, weight loss, constipation, intestinal blockages, bacterial infections, severe sneezing episodes runny nose, choking, enlarged colon, kidney problems, renal failure, abdominal pain and even death.

Apart from the toxic substances in the litter, the bacterial count in soiled cat litter can be so high that it alone can cause numerous health problems if ingested. Poisoning due to cat litter ingestion has been reported in humans, especially children.

Small children, who have a propensity to place non-eatable objects into the mouth, can suffer serious health ailments from the ingestion of cat litter. Other animals (e.g., dogs) with access to the cat litter box are also likely to ingest the litter and suffer health effects as described above.

Unfortunately, veterinarians may not associate the numerous health problems of their patient dogs with the ingestion of cat litter. Veterinarian visits and diagnosis and treatment charges increase as the pet owner searches for an answer and a cure to the mysterious illnesses that occur in an otherwise healthy pet who has ingested cat litter.

Cat litter is contained within a pan or box that may be enclosed within a litter box cover. The cover confines the litter spillage when the cat uses the litter box and may reduce litter odor in the surrounding area. The cover also keeps the soiled cat litter out of sight. A typical litter box cover comprises an upper portion releasably affixed to a lower portion, and further defines a front opening through which the cat enters the cover to access the litter box. Unfortunately, the opening also permits dogs and children to access the cat litter. The upper and lower portions are easily separated for cleaning and replacing of the litter within the covered box or pan.

Since the cover encloses the cat litter, it may offer the pet owner a false sense of security. A dog or a young child can easily gain access to the box interior where he/she will be exposed to harmful bacteria and chemicals of the litter material. The child (or another pet) can reach into or crawl into the box through the front opening.

It is known that after using the litter box, the cat tends to scatter the litter stuck to its paws as it exits the litter box cover.

It is desired to further improve cat litter box covers to limit access to the cat litter by pets and children.

### BRIEF SUMMARY OF THE INVENTION

According to one embodiment, the present invention comprises an apparatus for attachment to a litter box cover comprising an upper and a lower cover portion and further defining an opening in a front surface thereof. The apparatus further comprises a front member having an upper and a lower edge, an upper member extending from the upper edge, a lower member extending from the lower edge, a rear member spaced apart from the front member and extending from the lower member, wherein the rear member comprises a support member and wherein the upper member is affixed to the upper cover portion and a lower edge of the opening supports the support member. In another embodiment the apparatus is integrated with a litter box cover during manufacturing.

### BRIEF DESCRIPTION OF THE FIGURES

The present invention can be more easily understood and the advantages and uses thereof more readily apparent when the following detailed description of the present invention is read in conjunction with the figures wherein:

FIG. 1 illustrates a litter box safety guard of the present invention affixed to a litter box cover.

FIGS. 2 and 3 illustrate different embodiments of a litter box safety guard according to the teachings of the present invention.

FIG. 4 illustrates a litter box cover for use with the litter box safety guard of the present invention.

FIG. 5 illustrates another embodiment of a litter box safety guard of the present invention.

In accordance with common practice, the various described device features are not drawn to scale, but are drawn to emphasize specific features relevant to the invention. Reference characters denote like elements throughout the figures and text.

### DETAILED DESCRIPTION OF THE INVENTION

Before describing in detail the exemplary structure according to the teachings of the present invention, it should be observed that the present invention resides primarily in a novel and non-obvious combination of elements and materials. So as not to obscure the disclosure with details that will be readily apparent to those skilled in the art, certain conventional elements and materials have been presented with lesser detail, while the drawings and the specification describe in greater detail other elements and materials pertinent to understanding the invention.

The present invention teaches a litter box cover (e.g., including a Litter Box Safety Guard) that limits litter box access by children and pets, thereby reducing health problems caused by litter exposure. Use of the litter box cover in conjunction with the litter box safety guard will prevent the tragic illnesses and needless suffering of animals and children by preventing access to the litter box. In a preferred embodiment, the invention further comprises an element for removing litter that adheres to the cat's paws as it exits the litter box cover, thereby eliminating the need to clean litter tracked from the box.

The present invention comprises a unique, inexpensive, attractive, practical, new and non-obvious cat litter box safety guard or cover that takes up little more space then the prior art litter box covers, but prevents dogs and young children from exposure to the toxic substances and bacteria in the litter.

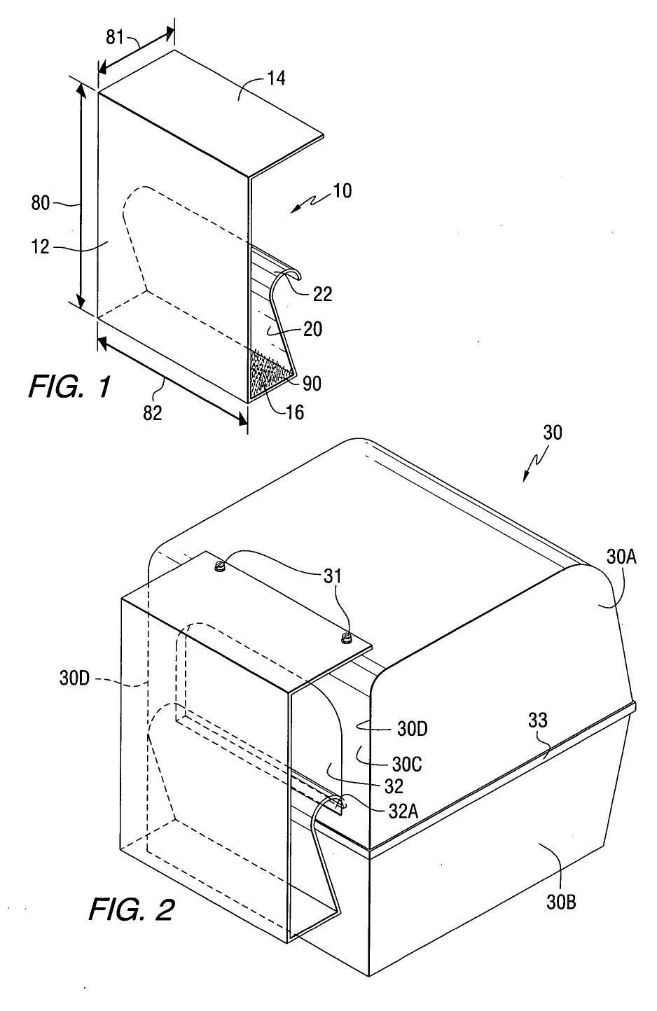

As can be seen in FIG. 1, the litter box safety guard 10 comprises a front face 12, an upper surface 14, a floor surface 16, a rear surface 20 and a support rail 22. In a preferred installation, the upper surface 14 is affixed to an upper cover portion 30A of a litter box cover 30 as illustrated in FIG. 2, using any known fastening components and materials, illustrated generally by fasteners 31, for example, but not limited to, an adhesive, loop and hook fastener strips, bolts and mating nuts and screws. In another embodiment, the upper surface 14 is formed as a unitary structure with the upper cover portion 30A.

The rail 32 is attached to or supported by a lower edge 32A of an opening 32 to support the safety guard 10 against the weight of a cat entering and exiting the litter box within the litter box cover 30 via the litter box safety guard 10 and the opening 32.

In the configuration illustrated in FIG. 2, the upper cover potion 30A can be separated from a lower cover portion 30B for accessing the litter box (for cleaning, for example) disposed within the cover 30, without removal of the safety guard 10. When the upper and lower cover portions 30A and 30B are separated (approximately along a line 33 in FIG. 2) the safety guard 10 is carried by the upper cover portion 30A.

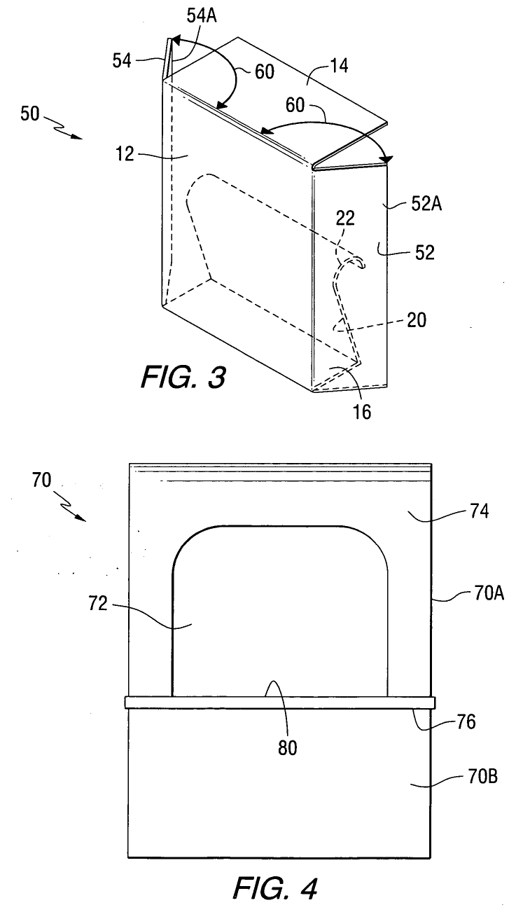

In another embodiment illustrated in FIG. 3, a litter box safety guard 50 comprises wings 52 and 54 extending laterally from the front face 12, each forming an angle 60 with the front face 12. The wings 52 and 54 provide an additional barrier for a dog or child to overcome as he/she attempts to enter the litter box cover 30. But the more agile cat can easily enter the litter box cover 30 through the safety guard 50 (or the safety guard 10).

A litter box cover 70 (see FIG. 4) comprising an upper cover portion 70A and a lower cover portion 70B differs from the litter box cover 30 in FIG. 1. An opening 72 in a front surface 74 extends to a plane that defines a lower edge 76 of the upper cover portion 70A. Thus the opening 72 lacks a lower edge, such as the lower edge 32A of the opening 32 in FIG. 1. When the litter box safety guard 10/50 is used with the litter box cover 70, the rail 22 rests on an upper edge 80 of the lower cover portion 70B. The litter box safety guard 10/50 does not interfere with separation of the upper and lower cover portions 70A and 70B, as when separated the safety guard 10/50 remains affixed to the upper cover portion 70A.

As can be seen from the above description and the accompanying FIGS. 1-4, access by dogs and small children to the litter box within the litter box cover 30/70 is prevented by the litter box safety guard 10/50. Small children and dogs cannot reach their heads or arms into the litter box cover 30/70.

Since the safety guard 10/50 extends forward of a front surface 30C (see FIG. 2) of the litter box cover 30/70, the cat is provided with added privacy when using the litter box, without requiring additional floor space for the litter box cover 30/70.

According to an embodiment of the invention, the safety guard 10/50 can be purchased as an after-market product and installed on a cat litter box cover 30/70 by a pet owner. In another embodiment, the safety guard 10/50 is permanently attached to the litter box cover 30/70 during manufacture of the litter box cover 30/70.

According to one embodiment a material of the litter box safety guard 10/50 comprises an acrylic plastic (including clear, colored or tinted acrylic material) and measures approximately 14″ to 16″ high, 3″ to 5″ long and 9″ to 12″ wide (respective dimensions 80, 81 and 82 in FIG. 1). A transparent material may be especially beneficial as the material tends to confuse a young child in that the child tends to reach through the transparent material instead of around it and into the litter box. Other suitable materials comprise, carbon-fiber, fiberglass, Lexan® polycarbonate resin (a registered trademark of The General Electric Company), rubber, metal or any of the various plastic materials, including a plastic material from which the litter box and/or the litter box cover is manufactured.

When installed on the litter box cover 30/70, the distance from the front face 12 to the opening 32/72 is about five inches. In an embodiment comprising the wings 52 and 54, respective edges 52A and 54A of the wings 52 and 54 (see FIG. 3) are about 3½ to about 4 inches from vertical edges 30D of the cover 30 of FIG. 2. For convenience, preferably the dimensions of the safety guard 10/50 are dependent on the dimensions of the litter box 30/70 to which it is attached.

According to a preferred embodiment, a litter-releasing material 90 (see FIG. 1) for releasing the cat litter from the cat's paws as the cat exits the litter box cover 30/70 is disposed on the floor surface 16. Outdoor artificial turf and rubber mat material comprising vertical nubs extending upwardly from a substrate are examples of suitable material. The litter-releasing material 90 can be affixed to the floor surface 16 of the safety guard 10/50 using known hook and loop fastening techniques for easy removal and cleaning.

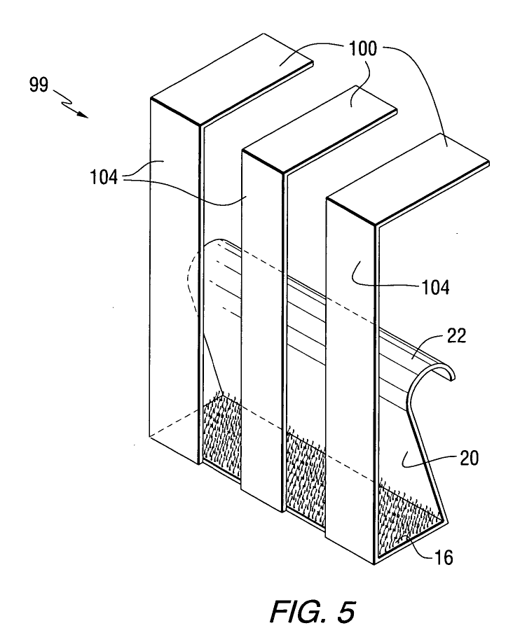

Although the various embodiments of the litter box safety guard have been described as comprising various connected surfaces and elements, in other embodiments one or more of the surfaces and elements can be replaced by structural members (elongated members, for example) to provide the barrier and support functions of the guard surfaces. For example, in another embodiment of a litter box safety guard 99 illustrated in FIG. 5, the upper surface comprises a plurality of elongated members 100 extending from a front face further comprising a plurality of elongated members 104. The members 100 and 104 are appropriately spaced and sized to provide the barrier functionality of the safety guard, while providing sufficient support for affixing the guard to the upper cover portion 30A. In yet another embodiment one or more of the floor surface 16 and the rear surface 20 may comprise a plurality of elongated members.

Thus as can be seen, the present invention comprises a unique, inexpensive, attractive and practical cat litter box attachment that takes up no more space then the litter box cover and prevents dogs and young children from accessing the toxic substances contained within the litter box. Advantages of the litter box safety guard include its practicality, durability, convenience and ease of use. It is lightweight, relatively inexpensive, and easy to attach to the litter box cover. In one embodiment the litter box safety guard is molded directly onto the litter box cover at the point of manufacture. With the litter box safety guard installed on a cat litter box cover, the upper and lower cover portions can be easily removed for cleaning the litter box. The extended front section of the safety guard also provides the cat with added privacy and protection from an assertive dog when using the litter box, without requiring additional space for placement of the litter box itself.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments as set forth herein. In addition, modifications may be made to adapt the teachings of the present invention to a particular application or to a specific box cover without departing from its essential scope. Therefore, it is intended that the invention not be limited to the particular embodiments disclosed, but that the invention include all embodiments falling within the scope of the appended claims.

What is claimed is:

1. An apparatus for attachment to a litter box cover comprising an upper and a lower cover portion and further defining an opening in a front surface thereof, the apparatus comprising:
a front member having an upper and a lower edge;
an upper member extending from the upper edge;
a lower member extending from the lower edge;
a rear member spaced apart from the front member and extending from the lower member, wherein the rear member comprises a support member, and
wherein the upper member is affixed to the upper cover portion and a lower edge of the opening supports the support member.

2. The apparatus of claim 1 wherein the lower member comprises a litter releasing surface.

3. The apparatus of claim 1 further comprising a litter releasing material affixed to the lower member.

4. The apparatus of claim 3 wherein the litter releasing material comprises one of artificial turf and a rubber mat material comprising vertical nubs extending upwardly from a base.

5. The apparatus of claim 1 further comprising first and second wing members extending from first and second side edges of the front member, the wing members extending in a direction toward the litter box cover when the apparatus is attached to the litter box cover.

6. The apparatus of claim 1 wherein a shape of one or more of the front member, the upper member, the lower member and the rear member comprises a planar shape or a plurality of elongated members.

7. The apparatus of claim 1 wherein a material of one or more of the front member, the upper member, the lower member and the rear member comprises one of a transparent material, carbon-fiber, acrylic, fiberglass, a polycarbonate resin, rubber, metal and plastic materials.

8. A litter box cover for enclosing a litter box, the cover comprising:
an upper cover portion comprising a first surface and first sidewalls extending therefrom defining a first interior space, the first sidewalls terminating in a first peripheral edge, the upper cover portion defining an opening in one of the first sidewalls, the opening bounded by a first lower edge;
a lower cover portion comprising a second surface and second sidewalls extending therefrom defining a second interior space, the second sidewalls terminating in a second peripheral edge adapted for engaging the first peripheral edge;
a front member having an upper edge and a second lower edge, wherein the front member is spaced apart from the opening;
an upper member extending from the upper edge in a direction toward the upper cover portion and supported by the upper cover portion;
a lower member extending from the second lower edge; and
a rear member spaced apart from the front member and extending from the lower member, the rear member comprising a support member, wherein the first lower edge of the opening supports the support member.

9. The apparatus of claim 8 wherein the lower member comprises a litter releasing surface.

10. The apparatus of claim 8 further comprising a litter releasing material affixed to the lower member.

11. The apparatus of claim 10 wherein the litter releasing material comprises one of artificial turf and a rubber mat material comprising vertical nubs extending upwardly from a base.

12. The apparatus of claim 8 further comprising first and second wing members extending from spaced apart first and second side edges of the front member, the wing members extending in a direction toward the upper cover portion.

13. The apparatus of claim 8 wherein a shape of one or more of the front member, the upper member, the lower member and the rear member comprises a planar shape or a plurality of elongated members.

14. The apparatus of claim 8 wherein a material of one or more of the front member, the upper member, the lower member and the rear member comprises a transparent material, carbon-fiber, acrylic, fiberglass, a polycarbonate resin, rubber, metal and plastic materials.

15. An apparatus for attachment to a litter box cover comprising an upper and a lower cover portion, the cover further defining an opening in the upper cover portion to permit access to a litter box within the cover, the apparatus comprising:
a guard having a first member disposed forward of the opening with a sufficient distance between the first member and the opening to permit a cat to enter the litter box through the opening, a first region of the first member attached to a first region of the upper cover portion and a second region of the first member attached to a second region of the upper cover portion;
wherein the first region and the second region of the first member are related such that the guard is supported against substantial vertical displacement when the cat enters the litter box cover through a space between the first member and the opening, and wherein the upper cover portion and the lower cover portion are separable, and wherein the guard is supported by the upper cover portion when the upper and lower cover portions are in a separated configuration.

16. The apparatus of claim 15 wherein a region of the first member supporting the cat as it exits the opening comprises a litter releasing surface.

17. The apparatus of claim 16 wherein the litter releasing material comprises one of artificial turf and a rubber mat material comprising vertical nubs extending upwardly from a base.

18. The apparatus of claim 15 further comprising first and second wing members extending from spaced apart first and second side edges of the first member, the wing members extending in a direction toward the upper cover portion when the apparatus is attached to the litter box cover.

19. The apparatus of claim 15 wherein a material of the guard comprises a transparent material, carbon-fiber, acrylic, fiberglass, a polycarbonate resin, rubber, metal and plastic materials.

20. A litter box cover for enclosing a litter box, the cover comprising:
an upper cover portion comprising a first surface and first sidewalls extending therefrom defining a first interior space, the first sidewalls terminating in a first peripheral edge, the upper cover portion further defining an opening in one of the first sidewalls;
a lower cover portion comprising a second surface and second sidewalls extending therefrom defining a second interior space, the second sidewalls terminating in a second peripheral edge adapted for engaging the first peripheral edge;
a front member having an upper and a lower edge, wherein the front member is spaced apart from the opening;
an upper member extending from the upper edge in a direction toward the upper cover portion and supported by the upper cover portion;
a lower member extending from the lower edge; and
a rear member spaced apart from the front member and extending from the lower member, the rear member comprising a support member, wherein the second peripheral edge supports the support member.
